(19) United States
(12) Patent Application Publication
(10) Pub. No.: US 2026/0366093 A1
(43) Pub. Date: Nov. 19, 2026

(54) METHOD FOR OPERATING A DC ELECTRIC FURNACE FOR PRODUCING IRON SMELT AND MOLTEN SLAG

(71) Applicant: ThyssenKrupp Steel Europe AG, Duisburg (DE)

(72) Inventor: Daniel SCHUBERT, Duisburg (DE)

(73) Assignee: ThyssenKrupp Steel Europe AG, Duisburg (DE)

(21) Appl. No.: 19/139,475

(22) PCT Filed: Dec. 13, 2023
(86) PCT No.: PCT/EP2023/085565

§ 371 Date: Jun. 16, 2025

(30) Foreign Application Priority Data
Jan. 11, 2023 (DE) 10 2023 100 464.6

(51) Int. Cl. C21C 5/52; C21B 13/12; C21C 5/54

(52) U.S. Cl. CPC C21C 5/527; C21B 13/12; C21C 5/5229; C21C 5/54; C21C 2005/5235

(57) ABSTRACT

The invention relates to a method for operating a DC electric furnace having at least one top electrode and at least one bottom electrode for producing an iron melt and a liquid slag.

The invention relates to a method for operating a DC electric furnace for producing an iron melt and liquid slag.

Liquid iron production via fossil-based blast furnace routes produces a lot of CO₂.

Natural gas-driven direct reduction (plants) emits significantly less CO₂, but the result is a solid iron sponge. The direct reduction route also provides the possibility of working with high hy-drogen levels in the process gas, which can potentially reduce the total CO₂ emissions. The type of direct reduction process used, whether it be via vertical shafts or rotary kilns, does not play an essential role in this process, as long as solid iron sponge is produced as a product. High production outputs mean that such systems are more likely to operate in an economically optimal manner, and so there is no need to completely reduce the iron sponge.

The solid iron sponge must be melted in melting units, where different approaches, such as induction furnaces or electric arc furnaces or else melt reduction furnaces, can be used. In the melting process, the iron sponge is melted and the proportion already reduced is separated in the iron sponge from the non-reduced proportion into a metallic phase (iron melt). The non-reduced proportion is then discharged into the liquid slag in the usual melting process, which results in a non-optimal application and an increased amount of liquid slag with higher iron contents.

This disadvantage does not occur in manufacturing processes with a combined direct reduction process with a melt reduction furnace, but this melting process is necessarily dependent on a reducing agent in the form of carbon in the melting furnace. The iron melt thus produced (“electric furnace iron”) must then be further processed at least in a subsequent refining step, for example to form a steel melt. In order to be CO₂-neutral or reduced, the added carbon must be at least fossil-free and ideally the CO₂ generated during the process never leaves the process (carbon looping).

The use of DC electric furnaces for producing iron melts and liquid slags from charged solids containing iron and slag formers is prior art; see, for example, EP 0.657 549B1, EP 1 124 995 B1, DE 197 44 151C5.

The object of the present invention is to specify a for operating an electric melter, with which an optimal output and an amount of liquid slag that is reduced compared to the prior art and with a lower iron content can be achieved up to substantially complete removal of the iron contents.

Said object is achieved by a method having the features of claim 1. Further configurations are described in the dependent claims.

The invention relates to a method for operating a DC electric furnace having at least one top electrode and at least one bottom electrode for producing an iron melt and a liquid slag, comprising the following steps:-charging the smelter with solids comprising iron-containing materials and slag formers;-melting the solids to produce an iron melt and a liquid slag disposed on the iron melt, wherein, while the solids are melted, the top electrode functions as cathode and the bottom electrode functions as anode;-tapping the liquid slag and the iron melt; wherein, before the liquid slag and the iron melt are tapped, the top electrode is brought into contact with the liquid slag and a polarity reversal is performed and therefore the top electrode functions as anode and the bottom electrode functions as cathode.

In the simplest embodiment, the DC electric furnace has a top electrode and a base electrode. Depending on the geometry and embodiment of the electric furnace, however, two or three top electrodes and/or two or three bottom electrodes may also be provided. The following text refers to the top and bottom electrode, but these may be understood as a plurality. The operating principle/operation of DC electric furnaces is familiar to a person skilled in the art, such that, after charging the smelter with solids containing iron-containing material and slag formers, the step of melting the solids to produce an iron melt and a liquid slag disposed on the iron melt is initiated, wherein, while the solids are melted, the top electrode acts as cathode and the bottom electrode acts as anode. In particular, a stable and especially straight plasma arc from the cathode can thus hit the solids that are to be melted. In other words, the DC electric furnace is preferably operated as an arc furnace, wherein the top electrode is positioned at a distance from the solids that are to be melted. Alternatively, the top electrode can also be positioned in contact with the solids that are to be melted, wherein the solids are then heated by means of a joule effect. Both operating principles are familiar to a person skilled in the art.

If the solids have largely melted, according to the invention, before the liquid slag and the iron melt are tapped, the top electrode is brought into contact with the liquid slag and a polarity reversal is performed such that the top electrode functions as anode and the bottom electrode functions as cathode.

The contact between the top electrode and the liquid slag and the polarity reversal means that the oxygen still bound in the non-reduced proportions of the iron-containing materials, which have been transferred to the liquid slag during melting, can be separated such that liquid iron can also get into the iron melt through the reaction Fe₂O₃+e⁻→2 Fe+3/2 O₂ and thus less liquid slag, in particular with low to substantially no iron content, can be provided and thus tapped. The iron oxide is essentially electrochemically deoxidized by applying an electrical voltage according to the electrochemical series known to a person skilled in the art.

Contact with the liquid slag is to be understood not only superficially as placing the top electrode on the liquid slag surface, but can also be understood as meaning immersion in the liquid slag. However, contact with the iron melt located below the liquid slag must be avoided in order to prevent a direct short circuit between the anode and the cathode. A short circuit caused by direct contact with the iron melt would result in a significant deterioration of the efficiency, such that the immersion depth is limited to less than the thickness of the liquid slag.

The invention takes advantage of the fact that, in this configuration, fused-salt electrolysis takes place prior to tapping by reversing the polarity. The principle of fused-salt electrolysis is described by way of example in EP 2 609 231B1 , wherein, in comparison with the invention, the teaching in this document takes place using other parameters, namely a carbon dioxide-free production of liquid metal by using natural (non-reduced) ores. This temporary procedure has the advantage over the conventional methods for producing an iron melt and liquid slag that the yield of the iron melt is higher, especially with a comparable or even reduced energy requirement. In addition, the melting of pre-reduced iron does not have the disadvantage that the production output of iron is much higher overall than in the case of exclusive production using the fused-salt electrolysis from EP 2 609 231 B 1 mentioned by way of example, since only the non-reduced proportion of iron oxides in the liquid slag is reduced. In comparison to the fused-salt electrolysis mentioned by way of example, this also has the advantage that significantly shorter process times can be achieved.

According to one embodiment, the iron-containing material comprises or consists of iron sponge. The iron sponge obtained from a direct reduction process does not necessarily have to be completely reduced, and so the degree of metallization of the iron sponge used may be between 20 and 95%. In particular, the degree of metallization may be not more than 90%, preferably not more than 80%, preferably not more than 70%. The determination of the degree of metallization is known to a person skilled in the art, in particular can be determined by (Feₑₗₑₘₑₙₜₐₗ/Feₜₒₜₐₗ)*100 in the iron sponge.

According to one embodiment, a carbonaceous admixture can additionally be charged. The ad-ditional carbonaceous admixture contributes to increasing the carbon content in the iron melt. With the charging of the carbonaceous admixture, an enrichment of the carbon content in the iron melt to at least 2.50% by weight, in particular to at least 3.00% by weight, preferably to at least 3.50% by weight, preferably to at least 4.00% by weight can be achieved. Setting a value of more than 5.5% by weight of carbon in the iron melt is not technically expedient. The addi-tional carbonaceous admixture may be charged in solid, gaseous and/or liquid form. This can be effected via a solid form, for example biocoke, coke, charcoal; via a gaseous from as carbonaceous or hydrocarbonaceous gases, including foundry gases, especially coking furnace gas, converter gas, top gas from an electrical smelter; via a liquid form, for example alcohol, hydro-carbon, biofuel.

According to one embodiment, in order to improve or increase the recycling rate, scrap can additionally be charged. This can be done, for example, in such a way that >0 kg, in particular at least 20 kg, preferably at least 50 kg, preferably at least 80 kg up to 200 kg of scrap per tonne of iron melt produced can be charged.

According to one embodiment, the slag formers can be charged so as to establish a basicity B3 in the liquid slag of between 0.9 and 1.8. 3 may be, in particular, at least 1.0, preferably at least 1.1 and in particular at most 1.7, preferably at most 1.6. The basicity B 3 corresponds to the ratio of (CaO+Mg₂O) to (SiO₂+Al₂O₃), with the determination of the characteristic quanti-ties in the slag in the solid state being familiar to a person skilled in the art. The slag former comprises at least one or more of the elements from the group (CaO, Mg₂O, SiO₂, Al₂O₃). In the case of a preferred use of iron sponge, which is obtained from iron ore, consisting of oxidic iron (iron oxide) and gangue, where the proportions may differ depending on the mining site, in addition to gangue by direct reduction to metallic iron. If the gangue is not sufficient, slag formers are charged to set the basicity B3 that is to be achieved.

According to one embodiment, the energy required for melting is provided from renewable energy (solar, wind, water, biomass). As a result, the DC electric furnace can be operated in a more climate-neutral manner.

The DC electric furnace may preferably be a furnace of the Open Slag Bath Furnace type. These include electric reduction furnaces, especially DC arc reduction furnaces (DC Submerged Arc Furnace), which work using arc resistance heating by generating arcs between the electrode and the solids and/or the liquid slag or by heating the solids and/or the slag by means of a joule effect. Alternatively, melting furnaces with direct arc action, in particular DC arc melting furnaces (DC Electric Arc Furnace) or DC ladle furnaces (DC Ladle Furnace), can also be used. The invention is elucidated in detail by the working examples that follow, in conjunction with the drawing.

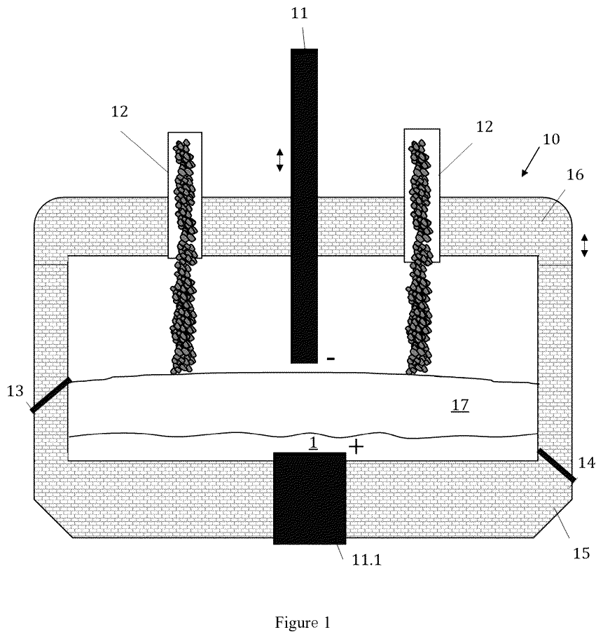

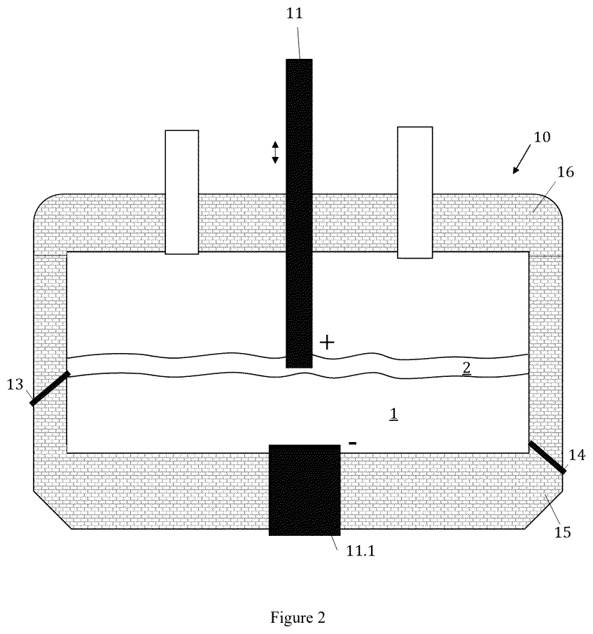

FIGS. 1 and 2 explain the invention using the example of a DC electric furnace (10) having at least one top electrode (11) and at least one bottom electrode (11.1) in a schematic side view. The DC electric furnace (10) comprises a vessel (15) and at least one bottom electrode (11.1), which is preferably arranged as a base electrode in the base of the vessel (15). The DC electric furnace (10) may comprise a lid (16) that can close the vessel (15) at the top and hence a defined or controlled, preferably reducing atmosphere can be adjusted within the DC electric furnace (10). The lid (16) may be in an essentially vertically movable arrangement; see double-headed arrow. If a lid (16) is provided, charging points (12) in the form of openings in the lid (16) are provided with appropriate supply lines by way of which the DC electric furnace (10) is charged. The DC electric furnace (10) is charged with solids (17) comprising iron-containing material and slag formers.

The iron-containing material comprises or consists of iron sponge, wherein the degree of metallization of the iron sponge may be between 50 and 95%. In addition, scrap can also be charged as another iron-containing material, for example with >0 kg up to 200 kg of scrap per tonne of iron melt (l) produced. The slag former comprises at least one or more of the elements from the group (CaO, Mg₂O, SiO₂, Al₂O₃) and can be measured so as to establish a basicity B3 in the liquid slag (2) of between 0.9 and 1.8. If necessary, a carbonaceous admixture can additionally be charged in such a way that the carbon content in the iron melt (l) is enriched to at least 2.50% by weight.

If the DC electric furnace (10) is sufficiently charged with solids (17), the operation of the DC electric furnace (10) can begin and the at least one top electrode (11) is positioned above the solids (17). An arc is ignited between the solids (17) and the top electrode (11), such that the solids (17) are gradually melted to produce an iron melt (1) and a liquid slag (2) disposed on the iron melt (2), wherein, while the solids are melted, the top electrode (11) acts as cathode (−) and the bottom electrode (11.1) acts as anode (+). The DC electric furnace (10) can continue to be successively charged with solids (17) until the desired output of the iron melt (1) is achieved. The energy required for melting is preferably supplied from renewable energy. If all solids (17) have largely melted, then the liquid slag (2) still contains non-reduced proportions of the iron-containing materials.

At the same time or with a time offset, the top electrode (11) is brought into contact with the liquid slag (2) and a polarity reversal is performed so that the top electrode (11) acts as anode (+) and the bottom electrode (11.1) acts as cathode (−). In the case of multiple top electrodes, not illustrated here, it is also conceivable to polarize them alternately as anode and cathode. Then reverse the polarity of the contact by preferably immersing, see double-headed arrow, the top electrode (11) into the liquid slags (2) without immersing in the iron melt (1). For the im-proved iron yield from the liquid slag (2), liquid electrolysis can also contribute to slag condi-tioning, until the desired basicity B3 is achieved. In particular, if the requirements for the iron melt (1) and liquid slag (2) are met, the iron melt (1) produced in the vessel (15) and the liquid slag (2) disposed on the iron melt (1) are ready for tapping.

The liquid slag (2) is tapped, for example, via a tapping point (13) and the iron melt (1) is tapped via a tapping point (14) in the vessel (15).

Nozzles (not shown) for influencing the movement of the iron melt (1) may be disposed in the vessel (15), in particular in the base of the vessel (15). The DC electric furnace (10) may also be mounted pivotably in order to enable tilting and hence tapping of liquid slag (2) in one direction and iron melt (1) in the other direction.

Likewise not shown is how the iron melt (1) is withdrawn and fed to a further processing step. The iron melt (1) is preferably sent to a treatment in order to reduce the carbon in the iron melt (1) to a desired level. This is effected, for example, by means of oxygen in what is called an oxygen blowing process, more preferably in a converter. The tapped liquid melt (2) is also preferably sent to a pelletization in order to produce slag for the building industry in particular. It is also not illustrated how the resulting gases are discharged and treated in the lid. Preferably, the gases and dusts from the melting phase or the electrolysis phase in each case can be withdrawn by suction separately, since the resulting waste gas contains oxygen.

The electrodes (top and bottom electrode) consist, in particular, of suitable material, for example WC, Ti-Ir, Pt, C, graphite or mixtures thereof. The mixtures can also be used as additives for Søderberg electrodes. Coated electrodes can also be used, for example ceramic rods that have been coated or doped with the aforementioned material. The electrical voltage is preferably at 3 V, in particular to generate an overpotential. A higher voltage increases the yield, but in turn increases the wear of the electrodes and reduces accom-panying elements.

1-6. (canceled)

7. A method for operating a DC electric furnace having at least one top electrode and at least one bottom electrode for producing an iron melt and a liquid slag, comprising the following steps:
charging the electric furnace with solids comprising iron-containing materials and slag formers;
melting the solids to produce an iron melt and a liquid slag disposed on the iron melt, wherein, while the solids are melted, the top electrode functions as cathode and the bottom electrode functions as anode; and
tapping the liquid slag and the iron melt;
wherein, before the liquid slag and the iron melt are tapped, the top electrode is brought into contact with the liquid slag and a polarity reversal is performed and therefore the top electrode functions as anode and the bottom electrode functions as cathode.

8. The method as claimed in claim 7, wherein the iron-containing material comprises or consists of sponge iron, wherein the degree of metallization of the sponge iron is between 20 and 95%.

9. The method as claimed in claim 8, wherein a carbonaceous admixture is additionally charged.

10. The method as claimed in claim 8, wherein scrap is additionally charged.

11. The method as claimed in claim 8, wherein the slag formers are charged so as to establish a basicity B3 in the liquid slag of between 0.9 and 1.8.

12. The method as claimed in claim 8, wherein the energy required for melting is provided from renewable energy.
